(19) United States
(12) Patent Application Publication
(10) Pub. No.: US 2012/0123014 A1
(43) Pub. Date: May 17, 2012

(54) OVERPRINT VARNISH FORMULATIONS

(75) Inventors: Michelle N. CHRÉTIEN, Mississauga (CA); Gordon SISLER, St. Catharines (CA); Christopher L. WAGNER, Etobicoke (CA)

(73) Assignee: XEROX CORPORATION, Norwalk, CT (US)

(21) Appl. No.: 12/948,409

(22) Filed: Nov. 17, 2010

(51) Int. Cl. C08F 20/22; G03G 15/20

(52) U.S. Cl. 522/182; 399/341

(57) ABSTRACT

An overprint varnish composition that is applied to a substrate that may have fuser oil on its surface. The varnish includes a wetting additive that has a strong affinity for the varnish and the fuser oil on the substrate. The overprint varnish is also included in a method and an apparatus.

### TECHNICAL FIELD

This disclosure relates to overprint varnish formulations for protecting images on a substrate. The disclosed overprint varnish formulations provide defect-free wetting of prints, with the additional benefit of low or no showthrough or grease marks on the substrate.

### RELATED APPLICATIONS

Commonly assigned patent application Ser. No. 12/642,569 describes a radiation curable solid overcoat composition that can be ink jetted. The overcoat composition includes a monomer, oligomer, or prepolymer, a curable wax, a non-curable wax, and a photoinitiator. The composition can also include a colorant. The composition is solid at room temperature and liquid at a temperature greater than about 40° C.

Commonly assigned patent application Ser. No. 11/821,355, which claims priority from U.S. Pat. No. 7,462,401 and U.S. Pat. No. 7,521,165, describes a xerographic print comprising a substrate with a toner-based image printed thereon. The printed substrate has a surface tension gradient field and is coated with a composition including a surfactant and a film-forming polymer. The composition has a liquid phase surface tension at 25° C. that does not exceed the low surface tension portions of the printed substrate by more than about 2 mN/m. The coating has substantially no pinholes and is sufficiently resistant to permeation by fuser oil to exhibit an effective absence of haze 24 hours after application.

Commonly assigned patent application Ser. No. 11/877,319 describes a method for applying varnish to a document. The varnish is a fluorescent varnish that contains at least one curable monomer or oligomer, at least one photoinitiator, and at least one fluorescent material. Upon exposure to activating radiation, the fluorescent material fluoresces and causes a visible change in the varnish. The varnish can be digitally printed upon one or more determined printed portions of the substrate.

Commonly assigned patent application Ser. No. 12/100,672 describes an overcoat composition. The composition includes a gellant, a monomer, and a photoinitator package. The composition is curable upon exposure to radiation and is substantially colorless and does not substantially yellow upon curing.

Commonly assigned patent application Ser. No. 12/144,233 describes a method of controlling the gloss of an image. The method includes determining a desired gloss of an image; setting the amount of at least one curable wax to include in an overcoat composition; preparing the overcoat composition to contain the set amount of the at least one curable wax; applying the overcoat composition over a substrate; and applying radiation to substantially cure the overcoat composition. The composition includes at least one gellant, at least one curable monomer, at least one curable wax and optionally at least one photoinitiator.

### BACKGROUND

Described herein are overprint varnish formulations that may be used to overcoat, for example, ink based images and xerographic based images. There are situations where an ink or toner may not impart sufficient robustness, durability, or permanence. The dominant approach for improving robustness, durability, and permanence is to apply a protective overcoat.

In conventional xerography, to enable successful fusing with complete retention of the image on paper, in other words without offset of the image onto a fuser roll, release-enabling additives are incorporated in the process. Conventionally, this release-enabling additive has been a silicone-based fuser oil. More recently, in some printer designs, a wax is incorporated into the toner particle to eliminate the complexity of handling fuser oil. In any event, the fused image has a surface layer of either silicone oil or wax.

The print surface can be difficult to coat when it is contaminated with fuser oil. Some compositions are sufficient to wet the print surface when the overprint varnish is applied offline because the fuser oil is given enough time to absorb into the substrate or image. However, when some other overcoat compositions are applied in-line to a recently fused image, surface-wetting defects such as pinholes, haze, and mottle are observed. Investigation of the finer scale grainy or speckled appearance on the surface indicates that there are small domains of fuser oil in the coated film. Oil phased domains on this fine scale are referred to as haze or mottle and have been observed to be a time dependent defect, i.e. mottle would emerge minutes to hours after coating. Therefore, there exists a need to develop an overprint varnish that can wet prints having the high level of oil contamination that is observed directly after fusing.

Previous liquid coatings have shown amelioration of surface wetting defects via inclusion of a surfactant at higher than standard levels. Numerous surfactants and modified polydimethylsiloxanes, such as BYK Chemie UV 3510, are known to enable surface wetting but none show improvement in phase change compositions, perhaps due to interaction with the phase change agent. The overprint varnish formulations of this disclosure overcome many of the challenges associated with conventional xerography.

### SUMMARY

Embodiments describe overprint varnish formulations, as well as methods and apparatuses for their use. The overprint varnish formulations of embodiments comprise a varnish vehicle of at least one of a monomer or an oligomer, and a wetting additive. The wetting additive has an affinity for the vehicle of the overprint varnish and the fuser oil on the substrate. The compositions may optionally comprise a wax or a phase change agent. Also disclosed are methods for applying the overprint varnish to a substrate and into printing apparatuses for creating a durable toner-based image on a substrate.

Embodiments provide excellent wetting of oil-contaminated prints even when applied within seconds of fusing. Embodiments provide enhanced robustness. For example, a typical image on paper is easily removed when scratched with a pencil of hardness 2 B, but the threshold for scratch is increased to 2H when using the ASTM Standard Test Method for Film Hardness by Pencil Test D3363. Embodiments also cure at speeds up to and likely beyond 250 fpm and with no yellowing on cure and the rheological properties are suitable for digital application.

### BRIEF DESCRIPTION OF THE DRAWINGS

FIG. 1 shows the Nanovea optical profiler roughness (Pa) for cured overprint varnishes applied digitally.

FIG. 2 shows underlying roughness and surface tension defects.

### EMBODIMENTS

This disclosure is not limited to the particular embodiments described herein, and some components and processes may be varied by one of ordinary skill, based on this disclosure.

Embodiments of the overprint varnish formulations comprise a varnish vehicle of at least one of a monomer or an oligomer, and a wetting additive. The wetting additive has an affinity for both the varnish vehicle, which may be primarily acrylate, and the fuser oil, which may be amino-functionalized silicone oil. Embodiments may also comprise, for example, a curable amide gellant phase change agent, a wax, a photoinitiator, a stabilizer, or other additives.

As used herein, the term “viscosity” refers to a complex viscosity, which is the typical measurement provided by a mechanical rheometer capable of subjecting a sample to a steady shear strain or a small amplitude sinusoidal deformation. In this type of instrument, the shear strain is applied by the operator to the motor and the sample deformation (torque) is measured by the transducer. Alternatively, a controlled-stress instrument, where the shear stress is applied and the resultant strain is measured, may be used. Such a rheometer provides a periodic measurement of viscosity at various plate rotation frequencies, ω, rather than the transient measurement of, for instance, a capillary viscometer. The reciprocating plate rheometer is able to measure both the in phase and out of phase fluid response to stress or displacement. The complex viscosity, η*, is defined as η*=n′−i η″; where η′=G″/ω, η″=G′/ω and i is √−1. Alternatively, a viscometer that can measure only the transient measurement of, for instance, a capillary or shear viscosity can also be used.

Embodiments described herein may be jetted at temperatures of from about 70° C. to about 100° C., such as from about 75° C. to about 90° C. At jetting, the overprint varnish formulations may have a viscosity of from about 5 to about 16 cPs, such as from about 8 to about 13 cPs, for example from about 9 to about 10 cPs. The overprint varnish formulations are thus ideally suited for use in ink jet devices.

“Wetting additive” refers to an additive having an affinity for both fuser oil, often used in xerographic printing, such as an amino-functionalized silicone oil, and the varnish vehicle, which can be primarily acrylate. The wetting additive can be selected by both its oil-philic and acrylate-philic properties and can be a high molecular weight silicone acrylate fluid. The wetting additive can be, for example, silicon-based and can have, for example, a functional moiety that has an affinity for the varnish vehicle.

When the fuser oil is, for example, a silicone-based fuser oil, suitable wetting additives may include, but are not limited to acrylated silicones, for example Polydimethylsiloxane Acrylate Copolymer (such as Silmer Acr-Di-50, available from Siltech); acrylated alkyl siloxanes; acrylated alkyl siloxanes; acrylated aryl siloxanes; acrylated allyl siloxanes; and the like. Other examples of suitable wetting additives include methacryloxy functionalized silicones such as Dow Additive 31.

The wetting additive typically has a low viscosity, for example, from about 20 to about 500 cPs, such as from about 50 to about 300 cPs, or from about 100 to about 200 cPs at 90° C. The wetting additives may be included in an amount from about 0.1% to about 5%. For example, as an additive in a UV curing system, the wetting additive may be included in an amount from about 0.1% to about 3.0%, for example from 0.2% to about 2%, such as from about 0.5% to about 1.0%.

Examples of suitable radiation curable monomers that may be used in the overprint varnish formulation may include propoxylated neopentyl glycol diacrylate (such as SR9003 from Sartomer), diethylene glycol diacrylate, triethylene glycol diacrylate, butanediol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, propoxylated glycerol triacrylate, isobornyl methacrylate, lauryl acrylate, lauryl methacrylate, neopentyl glycol propoxylate methylether monoacrylate, isodecylmethacrylate, caprolactone acrylate, 2-phenoxyethyl acrylate, isooctylacrylate, isooctylmethacrylate, butyl acrylate, tricyclodecane dimethanol diacrylate, dioxane glycol diacrylate, mixtures thereof and the like. As relatively non-polar monomers, mention may be made of isodecyl(meth)acrylate, caprolactone acrylate, 2-phenoxyethyl acrylate, isooctyl(meth)acrylate, and butyl acrylate. In addition, multifunctional acrylate monomers/oligomers may be used not only as reactive diluents, but also as materials that can increase the cross-link density of the cured image, thereby enhancing the toughness of the cured images.

Examples of suitable radiation curable oligomers that may be used in the overprint varnish formulations have a low viscosity, for example, from about 50 cPs to about 10,000 cPs, such as from about 75 cPs to about 7,500 cPs or from about 100 cPs to about 5,000 cPs. Examples of such oligomers may include CN549, CN131, CN131B, CN2285, CN 3100, CN3105, CN132, CN133, CN 132, available from Sartomer Company, Inc., Exeter, Pa., Ebecryl 140, Ebecryl 1140, Ebecryl 40, Ebecryl 3200, Ebecryl 3201, Ebecryl 3212, available from Cytec Industries Inc, Smyrna Ga., PHOTOMER 3660, PHOTOMER 5006F, PHOTOMER 5429, PHOTOMER 5429F, available from Cognis Corporation, Cincinnati, Ohio, LAROMER PO 33F, LAROMER PO 43F, LAROMER PO 94F, LAROMER UO 35D, LAROMER PA 9039V, LAROMER PO 9026V, LAROMER 8996, LAROMER 8765, LAROMER 8986, available from BASF Corporation, Florham Park, N.J., and the like.

In embodiments, the curable monomer includes both a propoxylated neopentyl glycol diacrylate (such as SR9003 from Sartomer) and a dipentaerythritol pentaacrylate (such as SR399LV from Sartomer). The inclusion of the pentaacrylate is advantageous in providing more functionality, and thus more reactivity, compared to the diacrylate. However, the amount of the pentaacrylate needs to be limited in overprint varnish formulations as too much can adversely affect the viscosity of the composition at application temperatures. The pentaacrylate thus makes up 10% by weight or less of the composition, such as 0.5 to 5% by weight of the composition.

The curable monomer in embodiments can be included in the overprint varnish composition in an amount of, for example, about 20 to about 95% by weight of the overprint varnish composition, such as about 30 to about 85% by weight of the overprint varnish composition, or about 40 to about 75% by weight of the overprint varnish composition. Oligomers may be optionally used in the overprint varnish composition in an amount of from 0 to about 30% by weight, such as from about 0 to about 25% by weight of the overprint varnish composition or from about 0 to about 20% by weight of the overprint varnish composition. Monomers and oligomers may also be mixed. The UV curable varnish may also include additional polymeric components, as desired.

The overprint varnish formulations may comprise phase change agents, including curable amide gellant phase change agents. “Phase change agent” refers to an additive that functions to increase the viscosity of the overprint varnish composition within a desired temperature range. In particular, the gelling agent forms a solid-like gel in the overprint varnish formulations at temperatures below the gel point of the gelling agent, for example, below the temperature at which the overprint varnish composition is jetted. For example, embodiments range in viscosity from about 10³ to about 10⁷ cPs, such as from about 10^{3.5} to about 10^{6.5} cPs in the solid-like phase. These viscosities are obtained using a strain controlled rheometer equipped with a cone and plate, at a frequency of 1 Hz. The gel phase typically comprises a solid-like phase and a liquid phase in coexistence, wherein the solid-like phase forms a three-dimensional network structure throughout the liquid phase and prevents the liquid phase from flowing at a macroscopic level. The overprint varnish formulations exhibit a thermally reversible transition between the gel state and the liquid state when the temperature is varied above or below the gel point of the overprint varnish composition. This temperature is generally referred to as a sol-gel temperature or gel point. This cycle of gel reformation can be repeated a number of times, since the gel is formed by physical, non-covalent interactions between the gelling agent molecules, such as hydrogen bonding, aromatic interactions, ionic bonding, coordination bonding, London dispersion interactions, or the like.

In embodiments, the temperature at which the ink composition forms the gel state is any temperature below the jetting temperature of the ink composition, for example any temperature that is about 10° C. or more below the jetting temperature of the ink composition. In embodiments, the gel state may be formed at temperatures from about from about 40° C. to about 85° C., from about 40° C. to about 75° C., from about 45° C. to about 70° C., or from about 40° C. to about 65° C., such as about 60° C. There is a rapid and large increase in ink viscosity upon cooling from the jetting temperature at which the ink composition is in a liquid state, to the gel transition temperature, at which the ink composition converts to the gel state.

The overprint varnish formulations may be jetted directly onto the image receiving substrate. The overprint varnish composition may then be leveled by contact or non-contact leveling, for example as disclosed in U.S. patent application Ser. No. 12/023,979, filed Jan. 31, 2008, to Kovacs et al.; U.S. patent application Ser. No. 12/625,472 filed Nov. 24, 2009 to Sambhy et al.; U.S. patent application Ser. No. 12/544,031 filed Aug. 19, 2009 to Gervasi et al.; U.S. patent application Ser. No. 12/814,741 filed Jun. 14, 2010 to Sambhy et al.; U.S. patent application Ser. No. 12/256,670 filed Oct. 23, 2008 to Roof; U.S. patent application Ser. No. 12/256,690 filed Oct. 23, 2008 to Roof; and U.S. patent application Ser. No. 12/256,684 filed Oct. 23, 2008 to Roof.

Following jetting, the overprint varnish is typically cooled to below the gel point of the composition in order to take advantage of the properties of the gelling agent. The composition may then be exposed to curing energy for curing of the composition. The term “curable” describes, for example, a material that may be cured via polymerization, including for example free radical routes, and/or in which polymerization is photoinitiated though use of a radiation-sensitive photoinitiator. The term “radiation-curable” refers, for example, to all forms of curing upon exposure to a radiation source, including light and heat sources and including in the presence or absence of initiators. Exemplary radiation-curing techniques include, but are not limited to, curing using ultraviolet (UV) light, for example having a wavelength of 200-400 nm or more rarely visible light, optionally in the presence of photoinitiators and/or sensitizers, curing using electron-beam radiation, optionally in the absence of photoinitiators, curing using thermal curing, in the presence or absence of high-temperature thermal initiators (and which may be largely inactive at the jetting temperature), and appropriate combinations thereof. The viscosity of the overprint varnish composition further increases upon exposure to the suitable source of curing energy, such that it hardens to a solid; the viscosity of the cured overprint varnish composition is not routinely measurable.

The monomer, and optionally the gellant, in the composition contain functional groups that polymerize as a result of the exposure of one or more photoinitiators to UV light to readily crosslink, forming a polymer network. In the absence of photoinitiators these functional groups may polymerize as a result of exposure to e-beam radiation. This polymer network provides printed images with, for example, durability, thermal and light stability, and scratch and smear resistance. Thus, the composition is particularly well-suited for coating ink-based images and toner-based images on substrates subjected to heat and sunlight because the composition protects the image from cracking and fading, provides image permanence, and allows for overwriting in the absence of smearing and beading.

Gellants suitable for use in the radiation curable overprint varnish formulations include a curable gellant comprised of a curable polyamide-epoxy acrylate component and a polyamide component, a curable composite gellant comprised of a curable epoxy resin and a polyamide resin, amide gellants and the like. Inclusion of the gellant in the overprint varnish composition described herein permits the overprint varnish composition to coat a substrate (with or without an image thereon), without excessive penetration into the substrate because the viscosity of the overprint varnish composition is quickly increased as the overprint varnish composition cools. Excessive penetration of a liquid into a porous substrate such as paper can lead to an undesirable decrease in the substrate opacity. In embodiments, the curable gellant participates in the curing of the monomer(s) described herein. The increase in viscosity by including the gellant may also reduce the diffusion of oxygen into the overprint varnish because oxygen is an inhibitor of free radical polymerization.

The gellants suitable for use in the overprint varnish formulations described herein may be amphiphilic in nature in order to improve wetting when the overprint varnish composition is utilized over a substrate having silicone oil thereon. As used herein, amphiphilic refers to molecules that have both polar and non-polar parts of the molecule. For example, the gellants described herein may have long non-polar hydrocarbon chains and polar amide linkages.

Suitable composite gellants comprised of a curable epoxy resin and a polyamide resin are disclosed, for example, in commonly assigned U.S. Patent Application Publication No. 2007-0120921 A1, the entire disclosure of which is incorporated herein by reference. The epoxy resin component in the composite gellant can be any suitable epoxy group-containing material. In embodiments, the epoxy group-containing component is selected from among the diglycidyl ethers of either polyphenol-based epoxy resin or a polyol-based epoxy resin, or mixtures thereof. That is, in embodiments, the epoxy resin has two epoxy functional groups that are located at the terminal ends of the molecule. The polyphenol-based epoxy resin in embodiments is a bisphenol A-co-epichlorohydrin resin with not more than two glycidyl ether terminal groups. The polyol-based epoxy resin can be a dipropylene glycol-co-epichlorohydrin resin with not more than two glycidyl ether terminal groups. Suitable epoxy resins have a weight average molecular weight in the range of about 200 to about 800, such as about 300 to about 700. Commercially available sources of the epoxy resins are, for example, the bisphenol-A based epoxy resins from Dow Chemical Corp. such as DER 383, or the dipropyleneglycol-based resins from Dow Chemical Corp. such as DER 736. Other sources of epoxy-based materials originating from natural sources may be used, such as epoxidized triglyceride fatty esters of vegetable or animal origins, for example epoxidized linseed oil, rapeseed oil and the like, or mixtures thereof. Epoxy compounds derived from vegetable oils such as the VIKOFLEX line of products from Arkema Inc., Philadelphia Pa. may also be used. The epoxy resin component is thus functionalized with acrylate or (meth)acrylate, vinyl ether, allyl ether and the like, by chemical reaction with unsaturated carboxylic acids or other unsaturated reagents. For example, the terminal epoxide groups of the resin become ring-opened in this chemical reaction, and are converted to (meth)acrylate esters by esterification reaction with (meth)acrylic acid.

As the polyamide component of the epoxy-polyamide composite gellant, any suitable polyamide material may be used. In embodiments, the polyamide is comprised of a polyamide resin derived from a polymerized fatty acid such as those obtained from natural sources (for example, palm oil, rapeseed oil, castor oil, and the like, including mixtures thereof) or the commonly known hydrocarbon “dimer acid,” prepared from dimerized C-18 unsaturated acid feedstocks such as oleic acid, linoleic acid and the like, and a polyamine, such as a diamine (for example, alkylenediamines such as ethylenediamine, DYTEK® series diamines, poly(alkyleneoxy)diamines, and the like, or also copolymers of polyamides such as polyester-polyamides and polyether-polyamides. One or more polyamide resins may be used in the formation of the gellant. Commercially available sources of the polyamide resin include, for example, the VERSAMID® series of polyamides available from Cognis Corporation (formerly Henkel Corp.), in particular VERSAMID 335, VERSAMID 338, VERSAMID 795 and VERSAMID 963, all of which have low molecular weights and low amine numbers. The SYLVAGEL® polyamide resins from Arizona Chemical Company, and variants thereof including polyether-polyamide resins may be employed. The composition of the SYLVAGEL® resins obtained from Arizona Chemical Company are described as polyalkyleneoxydiamine polyamides with the general formula,

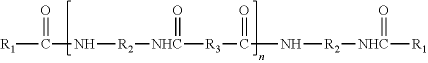

wherein R₁ is an alkyl group having from about twelve to about seventeen carbons, R₂ includes a polyalkyleneoxide, R₃ includes a C-6 carbocyclic group, and n is an integer of at least 1, such as from 1 to about 100, from about 1 to about 50 and from about 5 to about 25.

Suitable gellants comprised of a curable polyamide-epoxy acrylate component and a polyamide component are disclosed, for example, in commonly assigned, U.S. Patent Application Publication No. 2007-0120924 A1, the entire disclosure of which is incorporated herein by reference. The curable polyamide-epoxy acrylate is curable by virtue of including at least one functional group therein. As an example, the polyamide-epoxy acrylate is difunctional. The functional group(s), such as the acrylate group(s), are radiation curable via free-radical initiation and enable chemical bonding of the gellant to the cured ink vehicle. A commercially available polyamide-epoxy acrylate is PHOTOMER® RM370 from Cognis. The curable polyamide-epoxy acrylate may also be selected from within the structures described above for the curable composite gellant comprised of a curable epoxy resin and a polyamide resin.

The polyamide resin component may increase the elastic nature of the gel state of the overprint varnish composition. That is, the value of the elastic modulus (G′) is higher. When printing directly to paper, the requirement for higher elastic modulus (G′) for the overprint varnish composition is reduced. Any suitable polyamide materials may be used for the polyamide component of the gellant, and exemplary materials are polyether-polyamides with low molecular weights that are, for example, in the range of from 1,000 to 5,000 grams per mole, but can also be outside of this range, and have low amine number such as in the range of from 0 to 10. Commercially available sources of polyamide resin include, for example, SYLVAGEL® 1000 polyamide resin from Arizona Chemicals, and variants thereof.

Amide gellants suitable for use here are disclosed in U.S. Pat. Nos. 7,272,614 and 7,279,587, the entire disclosures of which are incorporated herein by reference.

In one embodiment, the amide gellant may be a compound of the formula

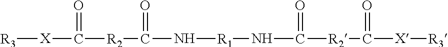

wherein:

R₁ can be selected from:
(i) an alkylene group (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group) having from about 1 carbon atom to about 12 carbon atoms, such as from about 1 carbon atom to about 8 carbon atoms or from about 1 carbon atom to about 5 carbon atoms,
(ii) an arylene group (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group) having from about 1 carbon atom to about 15 carbon atoms, such as from about 3 carbon atoms to about 10 carbon atoms or from about 5 carbon atoms to about 8 carbon atoms,
(iii) an arylalkylene group (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group) having from about 6 carbon atoms to about 32 carbon atoms, such as from about 6 carbon atoms to about 22 carbon atoms or from about 6 carbon atoms to about 12 carbon atoms, or
(iv) an alkylarylene group (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group) having from about 5 carbon atoms to about 32 carbon atoms, such as from about 6 carbon atoms to about 22 carbon atoms or from about 7 carbon atoms to about 15 carbon atoms, wherein the substituents on the substituted alkylene, arylene, arylalkylene, and alkylarylene groups can be (but are not limited to) halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ and R₂′ each, independently of the other, can be selected from:
(i) alkylene groups (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group) having from about 1 carbon atom to about 54 carbon atoms, such as from about 1 carbon atom to about 48 carbon atoms or from about 1 carbon atom to about 36 carbon atoms,
(ii) arylene groups (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group) having from about 5 carbon atoms to about 15 carbon atoms, such as from about 5 carbon atoms to about 13 carbon atoms or from about 5 carbon atoms to about 10 carbon atoms,
(iii) arylalkylene groups (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group) having from about 6 carbon atoms to about 32 carbon atoms, such as from about 7 carbon atoms to about 33 carbon atoms or from about 8 carbon atoms to about 15 carbon atoms, or
(iv) alkylarylene groups (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group) having from about 6 carbon atoms to about 32 carbon atoms, such as from about 6 carbon atoms to about 22 carbon atoms or from about 7 carbon atoms to about 15 carbon atoms, wherein the substituents on the substituted alkylene, arylene, arylalkylene, and alkylarylene groups can be (but are not limited to) halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring;

R₃ and R₃′ each, independently of the other, can be either:
(a) photoinitiating groups, such as groups derived from 1-(4-(2-hydroxyethoxy)phenyl)-2-hydroxy-2-methylpropan-1-one, of the formula

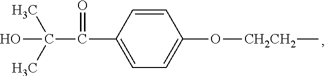

groups derived from 1-hydroxycyclohexylphenylketone, of the formula

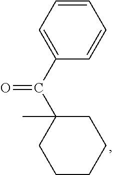

groups derived from 2-hydroxy-2-methyl-1-phenylpropan-1-one, of the formula

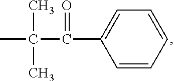

groups derived from N,N-dimethylethanolamine or N,N-dimethylethylenediamine, of the formula

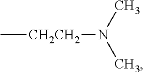

or the like, or:
(b) a group including:
   (i) an alkyl group (including linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may or may not be present in the alkyl group) having from about 2 carbon atoms to about 100 carbon atoms, such as from about 3 carbon atoms to about 60 carbon atoms or from about 4 carbon atoms to about 30 carbon atoms,
   (ii) an aryl group (including substituted and unsubstituted aryl groups, and wherein heteroatoms, such as oxygen, nitrogen, sulfur, silicon, phosphorus, boron, and the like either may or may not be present in the aryl group) having from about 5 carbon atoms to about 100 carbon atoms, such as from about 5 carbon atoms to about 60 carbon atoms or from about 6 carbon atoms to about 30 carbon atoms, such as phenyl or the like,
   (iii) an arylalkyl group (including substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkyl group) having from about 5 carbon atoms to about 100 carbon atoms, such as from about 5 carbon atoms to about 60 carbon atoms or from about 6 carbon atoms to about 30 carbon atoms, such as benzyl or the like, or
   (iv) an alkylaryl group (including substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylaryl group) having from about 5 carbon atoms to about 100 carbon atoms, such as from about 5 carbon atoms to about 60 carbon atoms or from about 6 carbon atoms to about 30 carbon atoms, such as tolyl or the like, wherein the substituents on the substituted alkyl, arylalkyl, and alkylaryl groups can be (but are not limited to) halogen atoms, ether groups, aldehyde groups, ketone groups, ester groups, amide groups, carbonyl groups, thiocarbonyl groups, sulfide groups, phosphine groups, phosphonium groups, phosphate groups, nitrile groups, mercapto groups, nitro groups, nitroso groups, acyl groups, acid anhydride groups, azide groups, azo groups, cyanato groups, isocyanato groups, thiocyanate groups, isothiocyanato groups, carboxylate groups, carboxylic acid groups, urethane groups, urea groups, mixtures thereof, and the like, wherein two or more substituents can be joined together to form a ring;
and X and X′ each, independently of the other, is an oxygen atom or a group of the formula —NR₄—, wherein R₄ is:
   (i) a hydrogen atom;
   (ii) an alkyl group, including linear and branched, saturated and unsaturated, cyclic and acyclic, and substituted and unsubstituted alkyl groups, and wherein heteroatoms either may or may not be present in the alkyl group, having from about 5 carbon atoms to about 100 carbon atoms, such as from about 5 carbon atoms to about 60 carbon atoms or from about 6 carbon atoms to about 30 carbon atoms,
   (iii) an aryl group, including substituted and unsubstituted aryl groups, and wherein heteroatoms either may or may not be present in the aryl group, having from about 5 carbon atoms to about 100 carbon atoms, such as from about 5 carbon atoms to about 60 carbon atoms or from about 6 carbon atoms to about 30 carbon atoms,
   (iv) an arylalkyl group, including substituted and unsubstituted arylalkyl groups, wherein the alkyl portion of the arylalkyl group can be linear or branched, saturated or unsaturated, and cyclic or acyclic, and wherein heteroatoms either may or may not be present in either the aryl or the alkyl portion of the arylalkyl group, having from about 5 carbon atoms to about 100 carbon atoms, such as from about 5 carbon atoms to about 60 carbon atoms or from about 6 carbon atoms to about 30 carbon atoms, or
   (v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, having from about 5 carbon atoms to about 100 carbon atoms, such as from about 5 carbon atoms to about 60 carbon atoms or from about 6 carbon atoms to about 30 carbon atoms, wherein the substituents on the substituted alkyl, aryl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring.

In one specific embodiment, R₂ and R₂′ are the same as each other; in another specific embodiment, R₂ and R₂′ are different from each other. In one specific embodiment, R₃ and R₃′ are the same as each other; in another specific embodiment, R₃ and R₃′ are different from each other.

In one specific embodiment, R₂ and R₂′ are each groups of the formula —C₃₄H₅₆₊ₐ— and are branched alkylene groups which may include unsaturations and cyclic groups, wherein a is an integer of 0, 1, 2, 3, 4, 5, 6, 7, 8, 9, 10, 11, or 12, including isomers of the formula

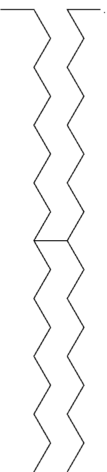

In one specific embodiment, R₁ is an ethylene (—CH₂CH₂—) group.

In one specific embodiment, R₃ and R₃′ are both

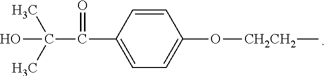

In one specific embodiment, the compound is of the formula

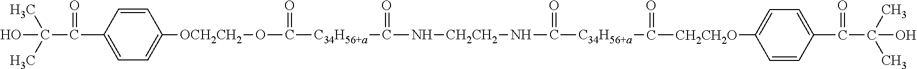

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12, including isomers of the formula

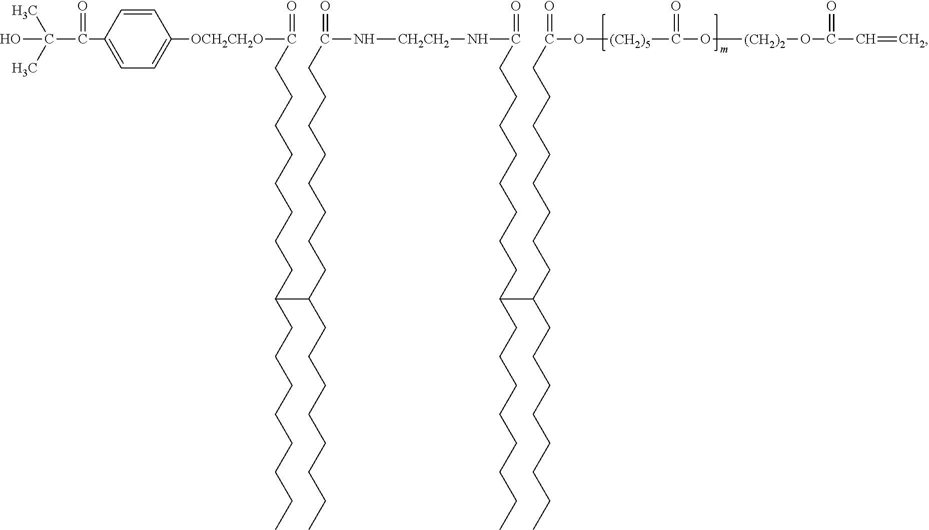

Additional specific examples of suitable amide gellants include those of the formula

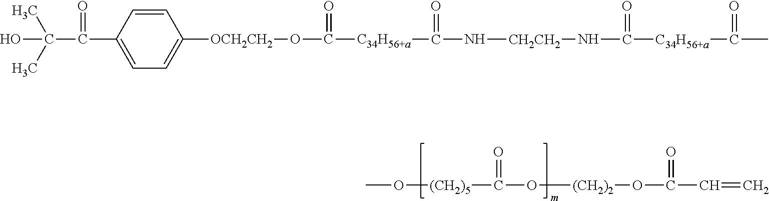

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12 and wherein m is an integer, including but not limited to embodiments wherein m is 2, including isomers of the formula

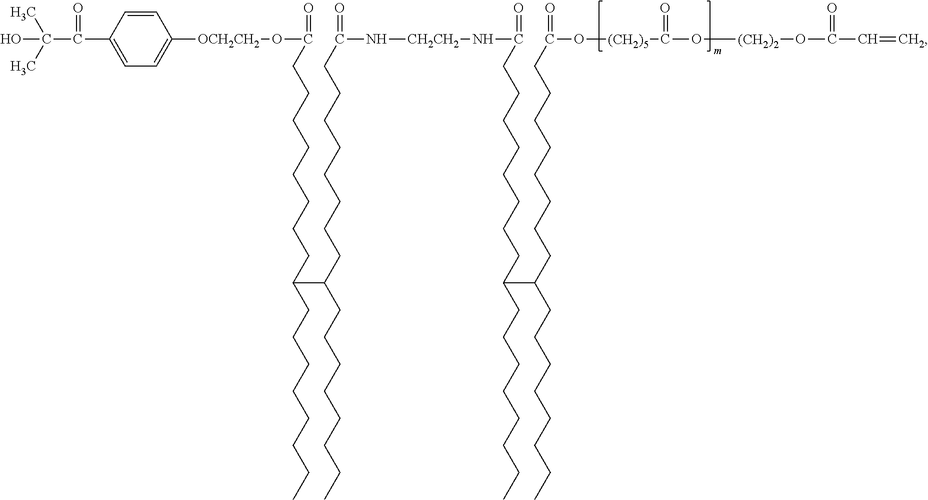

those of the formula

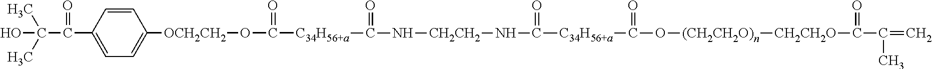

wherein —C₃₄H₅₆₊— represents a branched alkylene group which may include unsaturations and cyclic groups, wherein a is an integer of 0, 1, 2, 3, 4, 5, 6, 7, 8, 9, 10, 11, or 12 and wherein n is an integer, including but not limited to embodiments wherein n is 2 and wherein n is 5, including isomers of the formula

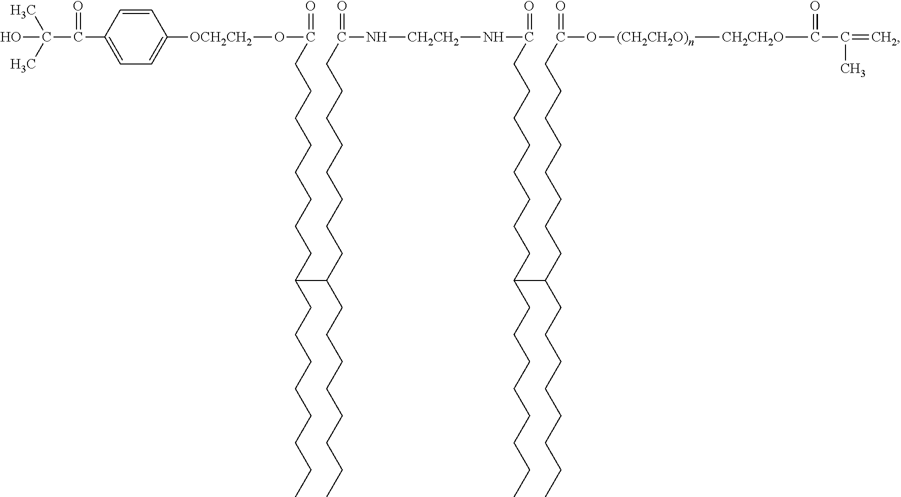

those of the formula

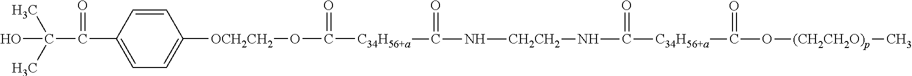

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12 and wherein p is an integer, including to embodiments wherein p is 2 and wherein p is 3, including isomers of the formula

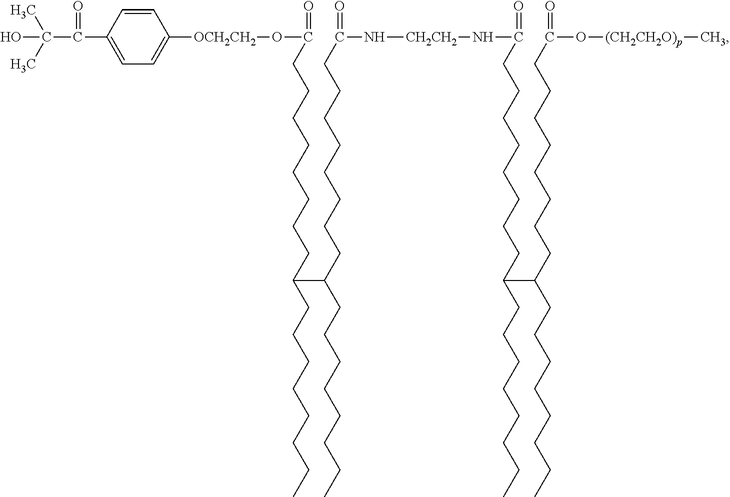

those of the formula

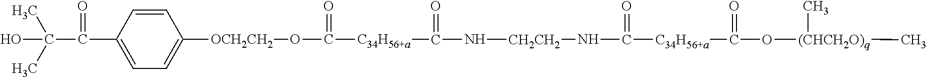

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12 and wherein q is an integer, including embodiments wherein q is 2 and wherein q is 3, including isomers of the formula

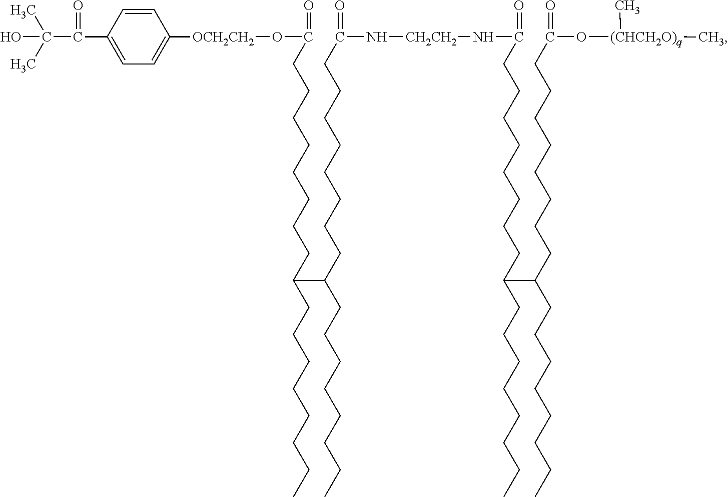

those of the formula

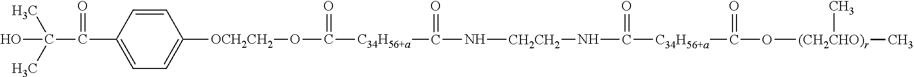

wherein —C₃₄H₅₆₊ₐ— represents a branched alkylene group which may include unsaturations and cyclic groups, wherein a is an integer of 0, 1, 2, 3, 4, 5, 6, 7, 8, 9, 10, 11, or 12 and wherein r is an integer, including embodiments wherein r is 2 and wherein r is 3, including isomers of the formula

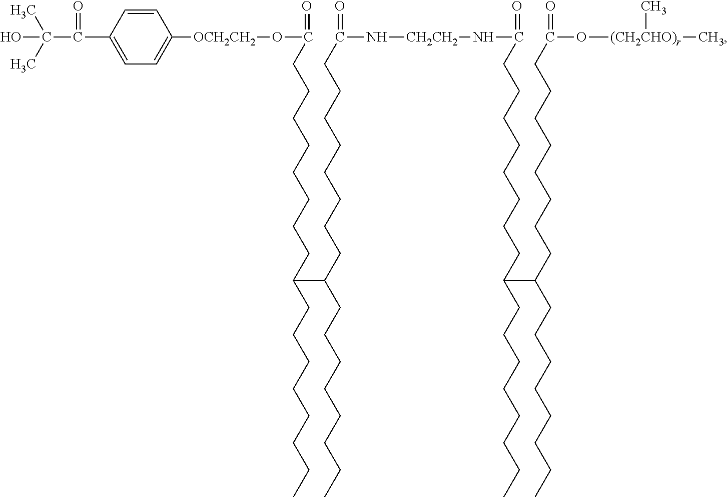

and the like, as well as mixtures thereof.

The overprint varnish formulations may include the gellant in any suitable amount, such as about 1% to about 50% by weight of the overprint varnish composition. In embodiments, the gellant can be present in an amount of about 2% to about 20% by weight of the overprint varnish composition, such as about 3% to about 10% by weight of the overprint varnish composition.

The composition also optionally includes a wax and, thus, the composition may be particularly well-suited for coating ink-based images, where the ink of the images contains at least one wax, and toner-based images, where the toner of the images contains at least one wax. “Wax” or “waxes” refer to, for example, any of the various natural, modified natural, and synthetic materials commonly referred to as waxes. A wax is solid at room temperature, at about 20° C. to about 25° C. Inclusion of the wax promotes an increase in viscosity of the varnish as it cools from the jetting temperature. Thus, the wax may assist the gellant in avoiding bleedthrough of the overprint varnish composition through the substrate.

The wax can be included in an amount of from, for example, about 1 to about 25% by weight of the UV curable varnish, such as about 2 or about 5 to about 10 or about 15% by weight of the UV curable varnish. In an embodiment, the curable wax can be included in the UV curable varnish in an amount of from about 2 to about 10% by weight of the UV curable varnish, such as about 3 to about 6% by weight of the UV curable varnish.

In specific embodiments, the wax is curable, “Curable wax” refers to any wax component that can be miscible with the other components and that will polymerize with the curable monomer or oligomer to form a polymer. Suitable examples of curable waxes include, but are not limited to, those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl. In embodiments, suitable examples of curable waxes may include hydroxyl-terminated polyethylene waxes, carboxylic acid-terminated polyethylene waxes. The curable waxes described herein may be cured with the disclosed monomer(s).

Suitable examples of hydroxyl-terminated polyethylene waxes that may be functionalized with a curable group include, but are not limited to, mixtures of carbon chains with the structure CH₃—(CH₂)ₙ—CH₂OH, where there is a mixture of chain lengths, n, where the average chain length can be in the range of about 16 to about 50, and linear low molecular weight polyethylene, of similar average chain length. Suitable examples of such waxes include, but are not limited to, the UNILIN® series of materials such as UNILIN® 350, UNILIN® 425, UNILIN® 550 and UNILIN® 700 with Mₙ approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL® 2033 (C-36 dimer diol mixture including isomers of the formula

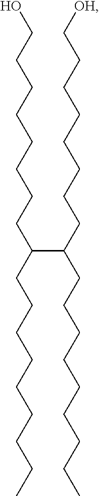

as well as other branched isomers that may include unsaturations and cyclic groups, available from Uniqema, New Castle, Del.; further information on C₃₆ dimer diols of this type is disclosed in, for example, “Dimer Acids,” Kirk-Othmer Encyclopedia of Chemical Technology, Vol. 8, 4^{th} Ed. (1992), pp. 223 to 237, the disclosure of which is totally incorporated herein by reference) can also be used. These alcohols can be reacted with carboxylic acids equipped with UV curable moieties to form reactive esters. Examples of these acids include acrylic and methacrylic acids, available from Sigma-Aldrich Co. In embodiments, suitable curable monomers include waxy acrylates, such as acrylates of UNILIN® 350, UNILIN® 425, UNILIN® 550 and UNILIN® 700.

Suitable examples of carboxylic acid-terminated polyethylene waxes that may be functionalized with a curable group include mixtures of carbon chains with the structure CH₃—(CH₂)ₙ—COOH, where there is a mixture of chain lengths, n, where the average chain length is about 16 to about 50, and linear low molecular weight polyethylene, of similar average chain length. Suitable examples of such waxes include, but are not limited to, UNICID® 350, UNICID® 425, UNICID® 550 and UNICID® 700 with Mₙ equal to approximately 390, 475, 565 and 720 g/mol, respectively. Other suitable waxes have a structure CH₃—(CH₂)ₙ—COOH, such as hexadecanoic or palmitic acid with n=14, heptadecanoic or margaric or daturic acid with n=15, octadecanoic or stearic acid with n=16, eicosanoic or arachidic acid with n=18, docosanoic or behenic acid with n=20, tetracosanoic or lignoceric acid with n=22, hexacosanoic or cerotic acid with n=24, heptacosanoic or carboceric acid with n=25, octacosanoic or montanic acid with n=26, triacontanoic or melissic acid with n=28, dotriacontanoic or lacceroic acid with n=30, tritriacontanoic or ceromelissic or psyllic acid, with n=31, tetratriacontanoic or geddic acid with n=32, pentatriacontanoic or ceroplastic acid with n=33. Guerbet acids, characterized as 2,2-dialkyl ethanoic acids, are also suitable compounds. Exemplary Guerbet acids include those containing 16 to 36 carbons, many of which are commercially available from Jarchem Industries Inc., Newark, N.J. PRIPOL® 1009 (C-36 dimer acid mixture including isomers of the formula

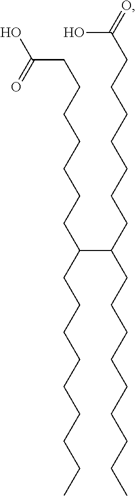

as well as other branched isomers that may include unsaturations and cyclic groups, available from Uniqema, New Castle, Del.; further information on C₃₆ dimer acids of this type is disclosed in, for example, “Dimer Acids,” Kirk-Othmer Encyclopedia of Chemical Technology, Vol. 8, 4^{th} Ed. (1992), pp. 223 to 237, the disclosure of which is totally incorporated herein by reference) can also be used. These carboxylic acids can be reacted with alcohols equipped with UV curable moieties to form reactive esters. Examples of these alcohols include, but are not limited to, 2-allyloxyethanol from Sigma-Aldrich Co.;

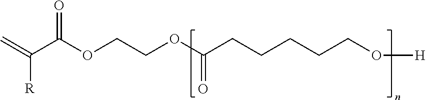

TONE M-101 (R═H, n_{avg}=1), TONE M-100 (R═H, n_{avg}=2) and TONE M-201 (R=Me, n_{avg}=1) from The Dow Chemical Company; and

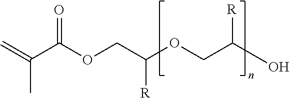

CD572 (R═H, n=10) and SR604 (R=Me, n=4) from Sartomer Company, Inc.

The curable wax can be included in embodiments in an amount of from, for example, about 1% to about 20% by weight of the overprint varnish composition, such as from about 1% to about 15% or from about 2% to 10% by weight of the overprint varnish composition. In embodiments, the curable wax can be included in the overprint varnish composition in an amount of from about 3% to about 10% by weight of the overprint varnish composition, such as from about 4% to about 9% by weight of the overprint varnish composition.

Embodiments may comprise at least one photoinitiator. The term “photoinitiator” refers to an additive that initiates curing, for example UV curing. Any photoinitiator that absorbs radiation, for example UV light radiation, to initiate curing of the curable components of the formulation may be used, although it is desirable if the photoinitiator does not substantially produce a yellow coloration upon cure. The radiation exposure need not be long, and may occur for example, about 0.05 to about 10 seconds, such as from about 0.2 to about 2 seconds. These exposure times are more often expressed as substrate speeds of the ink composition passing under a UV lamp. For example, the microwave energized, doped mercury bulbs available from UV Fusion are placed in an elliptical mirror assembly that is 10 cm wide; multiple units may be placed in series. Thus, a belt speed of 0.1 ms⁻¹ would require 1 second for a point on an image to pass under a single unit, while a belt speed 4.0 ms⁻¹ would require 0.2 seconds to pass under four bulb assemblies. The energy source used to initiate crosslinking of the curable components of the composition can be actinic, for example, radiation having a wavelength in the ultraviolet or visible region of the spectrum, accelerated particles, for example, electron beam radiation, thermal, for example, heat or infrared radiation, or the like. In embodiments, the energy is actinic radiation because such energy provides excellent control over the initiation and rate of crosslinking. Suitable sources of actinic radiation include mercury lamps, xenon lamps, carbon arc lamps, tungsten filament lamps, lasers, light emitting diodes, sunlight, electron beam emitters and the like. The curing light may be filtered or focused, if desired or necessary. The curable components of the ink composition react to form a cured or cross-linked network of appropriate hardness and robustness. In embodiments, the curing is substantially complete to complete, at least 75% of the curable components are cured (reacted and/or cross-linked). Embodiments will cure at speeds up to and likely beyond 250 fpm.

Examples of free-radical photoinitiators, suitable for use with compositions including acrylates, include benzophenones, benzoin ethers, benzil ketals, α-hydroxyalkylphenones, and acylphosphine photoinitiators, such as sold under the trade designations of IRGACURE and DAROCUR from Ciba. Specific examples of suitable photoinitiators include 2,4,6-trimethylbenzoyldiphenylphosphine oxide (available as BASF LUCIRIN TPO); 2,4,6-trimethylbenzoylethoxyphenylphosphine oxide (available as BASF LUCIRIN TPO-L); bis(2,4,6-trimethylbenzoyl)-phenyl-phosphine oxide (available as Ciba IRGACURE 819) and other acyl phosphines; 2-methyl-1-(4-methylthio)phenyl-2-(4-morphorlinyl)-1-propanone (available as Ciba IRGACURE 907) and 1-(4-(2-hydroxyethoxy)phenyl)-2-hydroxy-2-methylpropan-1-one (available as Ciba IRGACURE 2959); 2-hydroxy-1-(4-(4-(2-hydroxy-2-methylpropionyl)-benzyl)-phenyl)-2-methylpropan-1-one (available as Ciba IRGACURE 127); titanocenes; isopropylthioxanthone (ITX); 1-hydroxy-cyclohexylphenylketone; benzophenone; 2,4,6-trimethylbenzophenone; 4-methylbenzophenone; diphenyl-(2,4,6-trimethylbenzoyl)phosphine oxide; 2,4,6-trimethylbenzoylphenylphosphinic acid ethyl ester; oligo(2-hydroxy-2-methyl-1-(4-(1-methylvinyl)phenyl)propanone); 2-hydroxy-2-methyl-1-phenyl-1-propanone; benzyl-dimethylketal; and mixtures thereof.

An amine synergist, that is, co-initiators that donate a hydrogen atom to a photoinitiator and thereby form a radical species that initiates polymerization (amine synergists can also consume oxygen dissolved in the formulation—as oxygen inhibits free-radical polymerization its consumption increases the speed of polymerization), for example such as ethyl-4-dimethylaminobenzoate and 2-ethylhexyl-4-dimethylaminobenzoate, may also be included. This list is not exhaustive, and any known photoinitiator that initiates the free-radical reaction upon exposure to a desired wavelength of radiation, such as UV light, but does not become colored following irradiation, can be used without limitation.

In embodiments, the photoinitiator package may include at least one alpha-hydroxy ketone photoinitiator and at least one phosphinoyl type photoinitiator(s). One example of the alpha-hydroxy ketone photoinitiator can be IRGACURE 127, while one example of the phosphinoyl type photoinitiator can be IRGACURE 819, both available from Ciba-Geigy Corp., Tarrytown, N.Y. The ratio of the alpha-hydroxy ketone photoinitiator to the phosphinoyl type photoinitiator may be, for example, from about 90:10 to about 10:90, such as from about 80:20 to about 20:80 or from about 70:30 to about 30:70.

The total amount of photoinitiator included in the overprint varnish formulation may be, for example, from about 0 to about 15%, such as from about 0.5 to about 10%, by weight of the overprint varnish composition. The ratio of the alpha-hydroxy ketone photoinitiator to the phosphinoyl type photoinitiator may be, for example, from about 90:10 to about 10:90, such as from about 80:20 to about 20:80 or from about 70:30 to about 30:70. In embodiments, the composition may be free of photoinitiators, for example where e-beam radiation can be used as the curing energy source.

Embodiments may optionally comprise surfactants. “Surfactant” or “surfactants” refer to additives that can lower the surface tension of the composition to allow wetting and leveling of images on the substrate surface, if necessary, before curing. Any surfactant that has this capability may be used. However, in embodiments, the surfactant is not required, and need not be included. As noted above, surfactants may not interact with the phase change agent.

When present, surfactants include fluorinated alkyl esters, polyether modified polydimethylsiloxanes, having the structure:

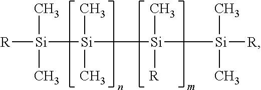

wherein the R groups are functional modifications, such as, for example, BYK®-UV3510 (BYK Chemie GmbH, Wesel, Germany), and BYK®-348 (BYK Chemie GmbH), and fluorosurfactants, such as, for example, ZONYL® FSO-100 (E.I. Du Pont de Nemours and Co., Wilmington, Del.), having the formula RfCH₂CH₂O(CH₂CH₂O)ₓH, wherein Rf═F(CF₂CF₂)_{y}, x=0 to about 15, and y=1 to about 7.

In embodiments, the amount of optional surfactant present in the overprint varnish composition may be from about 0 weight percent to about 15 weight percent of the overprint varnish composition, such as from about 0 weight percent to about 10 weight percent or from about 0.1 weight percent to about 5 weight percent of the overprint varnish composition.

Embodiments may also optionally comprise light stabilizers, UV absorbers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, waxes, oils, plasticizers, binders, electrical conductive agents, fungicides, bactericides, organic and/or inorganic filler particles, leveling agents, e.g., agents that create or reduce different gloss levels, opacifiers, antistatic agents, dispersants, pigments and dyes, and the like. The formulation can also include an inhibitor, for example, a hydroquinone, to stabilize the varnish by prohibiting or, at least, delaying, polymerization of the oligomer and monomer components during storage, thus increasing the shelf life of the composition. However, additives may negatively effect cure rate, and thus care must be taken when formulating an overprint varnish using optional additives.

“Antioxidant” or “antioxidants” refer to additives that protect the images from oxidation and protect the components of the overprint varnish from oxidation during the heating portion of the varnish preparation process. Specific examples of suitable antioxidant stabilizers include NAUGARD™ 524, NAUGARD™ 635, NAUGARD™ A, NAUGARD™ I-403, and NAUGARD™ 959, commercially available from Crompton Corporation, Middlebury, Conn.; IRGANOX™ 1010, and IRGASTAB UV 10, commercially available from Ciba Specialty Chemicals; GENORAD 16 and GENORAD 40 commercially available from Rahn AG, Zurich, Switzerland, and the like.

In embodiments, the overprint varnish formulation described herein may be prepared by mixing the curable monomer and the wetting additive at a temperature of from about 75° C. to about 100° C., such as from about 80° C. to about 95° C. or from about 75° C. to about 90° C., until homogenous. If a curable wax is utilized, it may be included in the mixture of monomer and wetting additive, and gellant if used. Once the mixture of the monomer and gellant are homogenous, then, if used, the photoinitiator or photoinitiators and optional surfactant may be added. Alternatively, the curable monomer, wetting additive, optional gellant, optional photoinitiator(s), optional wax and optional surfactant can be combined immediately. The resulting mixture is stirred at a temperature of from about 75° C. to about 100° C., such as from about 80° C. to about 95° C. or from about 75° C. to about 90° C., for from about 1 hour to about 3 hours, such as about 2 hours.

Embodiments can be used in image processing comprising generating an ink-based or toner-based image on a substrate, following the generation of the image, ink jetting the overprint varnish composition onto the substrate as a whole, onto the image as a whole, onto part(s) of the image, onto part(s) of the substrate, or any combination thereof, and curing the overprint varnish composition.

The substrate employed can be any appropriate substrate depending upon the end use of the print. Exemplary substrates include, but are not limited to, plain paper, coated paper, plastics, polymeric films, treated cellulosics, wood, xerographic substrates, ceramics, fibers, metals and mixtures thereof, optionally comprising additives coated thereon.

When coating a toner-based image, the fused toner-based print is obtained first and then subjected to an ink jet printer containing the jettable overprint varnish composition. The toner-based print can be prepared by any suitable conventional xerographic technique or variant thereof.

Similarly, when coating an ink-based image, the ink-based image is generated first and then subjected to an ink jet printer containing the jettable overprint varnish. If the ink-based image is formed using an ink jet printer, then the ink-based image can be subjected to a separate ink jet printer containing the jettable overprint varnish or the ink jet ink can be housed in the same ink jet printer as the varnish, whereby the varnish is coated onto the substrate and/or image as a colorless, transparent fluid after the ink jet ink image is formed. When the overprint varnish is coated over an ink-based image, particularly, an image produced using an ink jet printer, the image can be prepared by any suitable conventional process or variant thereof.

When embodiments are coated onto an image, parts thereof, substrate, and/or parts thereof, the composition can be applied at different levels of resolution. For example, the composition can be applied at the resolution of the print halftone dot, at the resolution of distinct part(s) of the image, or at a little less resolution than distinct part(s) of the image, allowing for some overlap of the composition onto nonimaged areas of the substrate. The typical composition deposition level is in an amount of from about 5 to about 50 picolitres drop size.

Once applied to the substrate, whether a composition is properly leveled can be measured as Pa roughness. Once applied to the substrate, whether a composition is properly leveled can be measured as Pa roughness. Pa roughness refers to International Standard ISO4287 “Geometrical Product Specifications (GPS)—Surface texture: Profile method—Terms, definitions and surface texture parameters.” Pa specifically is defined in section 4.2.1 as the arithmetical mean deviation of the assessed profile where P refers to the primary profile defined in section 3.2.1. Pa roughness can be measured using a variety of contacting and non-contacting profilometers, including the Nanovea ST400 Optical Profiler which is a non-contact instrument utilizing the principle of axial chromatism. For cured overprint coatings applied low Pa indicates reduced roughness hence good leveling while higher Pa represents increased roughness hence poor leveling prior to cure. In these embodiments low Pa roughness refers to Pa below about 6 microns and high Pa refers to roughness above 6 microns.

The overprint varnish can be applied in at least one pass over the image at any stage in the image formation using any known ink jet printing technique, such as, for example, drop-on-demand ink jet printing including, but not limited to, piezoelectric and acoustic ink jet printing. The application of the overprint varnish can be controlled with the same information used to form the image such that only one digital file is needed to produce the image and the overprint varnish composition. Embodiments can be fully digital. Additionally, embodiments can be applied directly after fusing. For example, embodiments can be applied within 5 seconds of fusing, such as, less than 1 second after fusing.

The energy source used to initiate crosslinking of the radiation curable oligomer and/or monomer components of the composition can be actinic, for example, radiation having a wavelength in the ultraviolet or visible region of the spectrum, accelerated particles, for example, electron beam radiation, thermal, for example, heat or infrared radiation, or the like. In embodiments, the energy is actinic radiation because such energy provides excellent control over the initiation and rate of crosslinking. Suitable sources of actinic radiation include, but are not limited to, mercury lamps, xenon lamps, carbon arc lamps, tungsten filament lamps, lasers, light emitting diodes, sunlight, and the like.

Actinic radiation as used herein refers to electromagnetic radiation having a sufficient energy to produce photochemical reactions. In the case of UV radiation, the light that is absorbed by the photoinitiator promotes an electron to a higher energy molecular orbital, the promoted electron will seek to return to a lower energy level or decay. One pathway that can occur during the electron's decay results in the homolytic cleavage of a covalent bond in the photoinitiator to provide two free radicals, one or both radicals may have the correct energy to react, with the reactive double bond of the (meth)acrylate or acrylate group found in the monomer, gellant, optional reactive wax or optional oligomer. This step is known as polymerization initiation and it sets off a chain reaction where the reactive double bonds rapidly link together as the free radical chain end moves through the overprint varnish film. The result is conversion of a monomer to a polymer or polymerization, and the film thereby hardens. Variations on this route are known, the promoted electron in some photoinitiators lacks the energy to react directly with a double bond in another molecule, instead it abstracts a hydrogen atom from a third molecule resulting in a free radical on the third molecule and this molecule initiates the radical polymerization. In the case of e-beam radiation, photoinitiators are not required as the energy of the e-beam is high enough to cause radical formation on the reactive double bond of the (meth)acrylate or acrylate group found in the monomer, gellant, optional reactive wax or optional oligomer and this initiation step leads to the same polymerization as with UV radiation and photoinitiators.

Ultraviolet radiation, especially from a medium pressure mercury lamp with a high speed conveyor under UV light, for example, about 20 to about 70 m/min may be desired, wherein the UV radiation is provided at a wavelength of about 200 to about 500 nm for about less than one second. In embodiments, the speed of the high speed conveyor is about 15 to about 35 m/min under UV light at a wavelength of about 200 to about 450 nm for about 10 to about 50 milliseconds (ms). The emission spectrum of the UV light source generally overlaps the absorption spectrum of the UV-initiator. Optional curing equipment includes, but is not limited to, a reflector to focus or diffuse the UV light, and a cooling system to remove heat from the UV light source.

The ability of embodiments to wet the substrate generally depends on its surface tension and viscosity. For example, if the surface tension is low, then the surface area covered by the overprint varnish will be high resulting in sufficient wetting of the substrate. Embodiments can have a surface tension ranging from about 18 dynes/cm to about 50 dynes/cm, more specifically, ranging from about 20 dynes/cm to about 40 dynes/cm, and, most specifically, ranging from about 20 dynes/cm to about 30 dynes/cm, at about 60° C. to about 90° C.

The viscosity of the overprint varnish ranges from about 5 cPs to about 10^{6.5} cPs, depending on the temperature. For example, the viscosity of the compositions is about 10 cPs at about 90° C. and about 10^{6.5} cPs at about 25° C. The jettable range is about 15 cPs to about 3 cPs at a temperature range of about 70° C. to about 95° C.

Embodiments are desirably substantially free, such as completely free, of colorant. “Substantially free of colorant” refers to the overprint varnish composition being substantially or completely transparent or clear after undergoing curing. For this, the overprint varnish may be substantially free of colorants, such as pigments, dyes, mixtures of pigments and dyes, mixtures of pigments, mixtures of dyes, and the like. The overprint varnish described herein does not yellow upon curing and remains substantially or completely transparent and clear, that is, little or no measurable difference in any of L* a* b* values or k, c, m, y is observed. Being “substantially non-yellowing” or “substantially or completely transparent or clear” refers to the overprint varnish composition changing color or hue upon curing in an amount of less than about 15%, such as less than about 10% or less than about 5%, for example about 0%.

Embodiments can be incorporated into a method for applying an overprint varnish to a substrate. Specifically, the method comprises providing a substrate with a toner-based image thereon, wherein the toner-based image has residual fuser oil present thereon, and at least partially coating the toner-based image and residual fuser oil with an overprint varnish. The overprint varnish of this method comprises at least one radiation curable monomer and/or oligomer and at least one wetting additive.

Where the residual fuser oil of this method is a functionalized silicone oil, then the wetting additive may be, for example, oil-phillic and acrylate-phillic acrylated silicone. Providing the substrate with the toner-based image thereon may comprise providing a substrate, generating an electrostatic latent image on a photoconductive imaging member, developing the latent image with a toner, and transferring the developed electrostatic image from the photoconductive imaging member to the substrate.

Embodiments may also be incorporated into a printing apparatus that creates a durable toner-based image on a substrate. The apparatus may comprise: a xerographic print engine connected to a digital coating device and a curing station, wherein the digital coating device applies an overprint varnish to a substrate with a toner-based image, wherein the overprint varnish comprises at least one radiation curable monomer and/or oligomer and at least one wetting additive. In the printing system of the present disclosure, the durable toner-based image may be obtained by generating an electrostatic latent image on a photoconductive imaging member, developing the latent image with a toner, transferring the developed electrostatic image from the photoconductive imaging member to the substrate, and at least partially coating the substrate with the overprint varnish. In the printing system of the present disclosure, the overprint varnish may be applied digitally to the substrate or with a toner-based image using, for example, piezoelectric inkjet, acoustic inkjet, continuous inkjet or the like.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

### Examples

The disclosure will be illustrated further in the following nonlimiting Example. The Example is intended to be illustrative only. The disclosure is not intended to be limited to the materials, conditions, process parameters, and the like, recited herein. Parts and percentages are by weight unless otherwise indicated.

Test 1: Wetting Properties

An overprint varnish composition having the components set forth in Table 1 is prepared by combining all components except photoinitiator and mixing by magnetic stirring at 90° C. for 30 min then adding the photoinitiators and stirring for an addition 30-60 minutes.

TABLE 1

| Component | Function | wt % |
|---|---|---|
| Curable amide gellant | Phase change | 7.5% |
| UNILIN 350-acrylate curable wax | Phase change | 5% |
| SR 399LV acrylate monomer (Sartomer) | Monomer | 5% |
| Acr-Di-50 Diacrylated silicone (Siltech) | Wetting Additive | 1% |
| IRGACURE 819 (Ciba) | Photoinitiator | 1% |
| IRGACURE 127 (Ciba) | Photoinitiator | 3.5% |
| IRGASTAB UV10 (Ciba) | Stabilizer | 0.2% |
| SR9003 acrylate monomer (Sartomer) | Monomer | 76.8% |
| TOTAL | | 100% |

The Contact Angle is measured between 0.4 and 0.6 seconds after the pendant drop contacts the surface, and is measured using FTA 200 instrument conducted at a temperature of 85° C. The results of the test are shown in Table 2 below.

TABLE 2

| | Fuser | Contact Angle | | |
|---|---|---|---|---|
| | Oil on | | | Std. |
| Overprint Coating | Substrate | Means | N | Dev. |
| Preferred Coating | No Oil | 22.2 | 67 | 4.62 |
| Preferred Coating | Oil | 31.0 | 85 | 3.42 |
| Conventional Coating | No Oil | 31.1 | 61 | 4.18 |
| Conventional Coating | Oil | 38.1 | 72 | 4.34 |

The contact angles reported in Table 2 indicate the substantial reduction in wetting as measured by sessile drop contact angle increase due to the presence of fuser oil on the substrate, and also the ability of the preferred coating, as shown in Table 1, to reduce the contact angle on an oiled substrate compared to a conventional coating.

Test 2: Pa Roughness

Example 2 is an embodiment comprising the components given in Table 3 below.

TABLE 3

| Component | Function | wt % |
|---|---|---|
| Curable amide gellant | Phase change | 7.5% |
| UNILIN 350-acrylate curable wax | Phase change | 5% |
| SR 399LV acrylate monomer (Sartomer) | Monomer | 5% |
| Dow 31 Additive | Wetting Additive | 2% |
| IRGACURE 819 (Ciba) | Photoinitiator | 1% |
| IRGACURE 127 (Ciba) | Photoinitiator | 3.5% |
| IRGASTAB UV10 (Ciba) | Stabilizer | 0.2% |
| SR9003 acrylate monomer (Sartomer) | Monomer | 75.8% |
| TOTAL | | 100% |

Example 2, having the components set forth in Table 3, is prepared by combining all components except photoinitiator and mixing by magnetic stirring at 90° C. for 30 min then adding the photoinitiators and stirring for an addition 30-60 minutes.

Example 3 is an embodiment comprising the components set forth above in Table 1 of Example 1. Example 3 is prepared in a manner identical to Example 1.

Comparative Example 1 is a UV coating comprising the components given in Table 4 below.

TABLE 4

| Component | Function | wt % |
|---|---|---|
| Curable amide gellant | Phase change | 7.5% |
| UNILIN 350-acrylate curable wax | Phase change | 5% |
| SR 399LV acrylate monomer (Sartomer) | Monomer | 5% |
| IRGACURE 819 (Ciba) | Photoinitiator | 1% |
| IRGACURE 127 (Ciba) | Photoinitiator | 3.5% |
| IRGASTAB UV10 (Ciba) | Stabilizer | 0.2% |
| SR9003 acrylate monomer (Sartomer) | Monomer | 77.8% |
| TOTAL | | 100% |

Comparative Example 1, having the components set forth in Table 4, was prepared by combining all components except photoinitiator and mixing by magnetic stirring at 90° C. for 30 min then adding the photoinitiators and stirring for an addition 30-60 minutes.

Comparative Example 2 is a version of Comparative Example 1 modified to improve wetting and leveling, comprising the components given in Table 5 below.

TABLE 5

| Component | Function | wt % |
|---|---|---|
| Curable amide gellant | Phase change | 7.5% |
| SR 399LV acrylate monomer (Sartomer) | Monomer | 5% |
| IRGACURE 819 (Ciba) | Photoinitiator | 1% |
| IRGACURE 127 (Ciba) | Photoinitiator | 3.5% |
| IRGASTAB UV10 (Ciba) | Stabilizer | 0.2% |
| SR9003 acrylate monomer (Sartomer) | Monomer | 82.8% |
| TOTAL | | 100% |

Comparative Example 2, having the components set forth in Table 4, was prepared by combining all components except photoinitiator and mixing by magnetic stirring at 90° C. for 30 min then adding the photoinitiators and stirring for an addition 30-60 minutes.

Comparative Example 3 is a version of Comparative Example 1 modified to improve wetting and leveling. Comparative Example 3 comprises the components given below in Table 6.

TABLE 6

| Component | Function | wt % |
|---|---|---|
| Curable amide gellant | Phase change | 7.5% |
| UNILIN 350-acrylate curable wax | Phase change | 5% |
| SR 399LV acrylate monomer (Sartomer) | Monomer | 5% |
| UV-3510 (BYK) | Wetting Additive | 1% |
| IRGACURE 819 (Ciba) | Photoinitiator | 1% |
| IRGACURE 127 (Ciba) | Photoinitiator | 3.5% |
| IRGASTAB UV10 (Ciba) | Stabilizer | 0.2% |
| SR9003 acrylate monomer (Sartomer) | Monomer | 76.8% |
| TOTAL | | 100% |

Comparative Example 3, having the components set forth in Table 5, was prepared by combining all components except photoinitiator and mixing by magnetic stirring at 90° C. for 30 min then adding the photoinitiators and stirring for an addition 30-60 minutes.

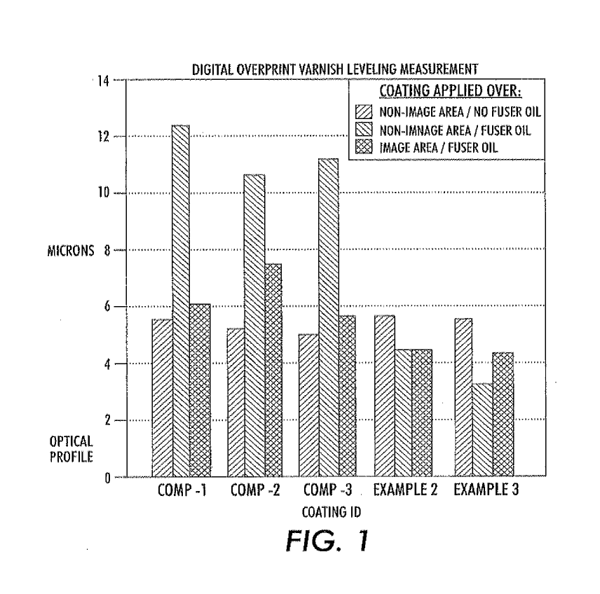

Examples 2 and 3 and Comparative Examples 1, 2, and 3 were applied over a Digital Color Elite Gloss coated paper. First, they were applied on a non-image area of the paper, which had never gone through a fuser. In the absence of fuser oil, leveling is similar for each coating with Pa between 5 and 6 microns, as indicated by the left-most bars on the Chart in FIG. 1.

Second, Examples 2 and 3 and Comparative Examples 1, 2, and 3 were applied over a non-image area after the paper went through an iGen 3 fuser, which added fuser oil to the paper. The Pa for Comparative Examples 1, 2, and 3 rises to 10-12 microns. The Pa for Examples 2 and 3 remain below 5 microns. Each as indicated by the middle bars on the Chart in FIG. 1.

Examples 2 and 3 and Comparative Examples 1, 2, and 3 were then applied over an image area after the paper went through an iGen 3 fuser, which adds fuser oil to the image on the paper. The Pa for Comparative Examples 1, 2, and 3 rises above 5 microns. The Pa for Examples 2 and 3 remain below 5 microns. Each as indicated by the right-most bars on the Chart in FIG. 1.

In the absence of fuser oil, leveling is good for each coating with Pa between 5 and 6 microns. However, when the paper is passed through the fuser, adding fuser oil, the Pa roughness for the comparative examples rises above 6 microns and the embodiments of this disclosure remain below 6 microns.

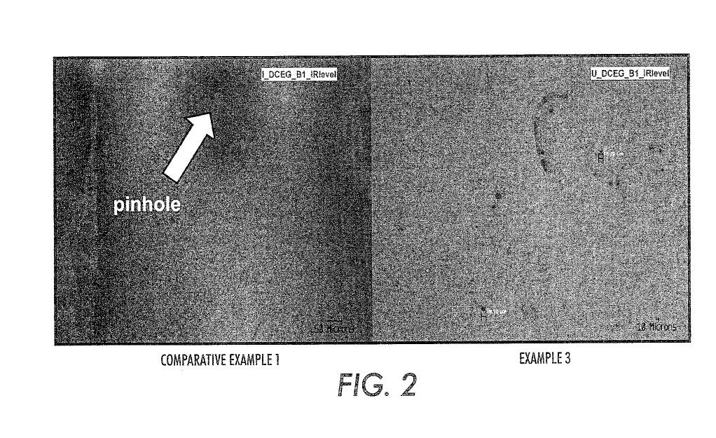

FIG. 2 shows underlying roughness and surface tension defects due to varnish leveling of Comparative Example 1 (image on left) compared to Example 3 (image on right), showing minimal defects and no pinholes.

While the present disclosure has been described with reference to the specific embodiments, it will be apparent to those skilled in the art that many alternatives, modifications, and variations can be made. It is intended to embrace such alternatives, modifications, and variations as may fall within the spirit and scope of the appended claims.

What is claimed is:

1. An overprint varnish configured to be applied digitally, comprising:
a varnish vehicle comprising at least one of a monomer, an oligomer, or a mixture thereof;
a siloxane-based wetting additive comprising a functional moiety that has an affinity for the varnish vehicle; and
optionally, a phase change agent and/or a photoinitiator.

2. The overprint varnish of claim 1, wherein the wetting additive is selected from a group consisting of acrylated silicone, acrylated alkyl siloxanes, acrylated alkyl siloxanes, acrylated aryl siloxanes, and acrylated allyl siloxanes.

3. The overprint varnish of claim 1, wherein the wetting additive is present in an amount of from about 0.1 percent to about 5 percent by weight of the varnish.

4. The overprint varnish of claim 1, wherein the wetting additive is present in an amount of about 1 to about 2 percent by weight of the varnish.

5. The overprint varnish of claim 1, wherein at least one monomer or oligomer is an acrylated monomer or oligomer.

6. The overprint varnish of claim 1, wherein the monomer is selected from a group consisting of propoxylated neopentyl glycol diacrylate, diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, propoxylated glycerol triacrylate, isobornyl methacrylate, lauryl acrylate, lauryl methacrylate, neopentyl glycol propoxylate methylether monoacrylate, isodecylmethacrylate, caprolactone acrylate, 2-phenoxyethyl acrylate, isooctylacrylate, isooctylmethacrylate, tricyclodecane dimethanol diacrylate, dioxane glycol diacrylate, butanediol diacrylate, and butyl acrylate, or mixtures thereof.

7. The overprint varnish of claim 1, wherein at least one monomer is present in the amount of from about 20 percent to about 95 percent by weight of the varnish.

8. The overprint varnish of claim 1, wherein the varnish is curable at a speed of at least 250 fpm without yellowing.

9. The overprint varnish of claim 1, wherein the varnish maintains a Pa roughness of below 6 microns after coating a substrate or an image that has a fuser oil thereon.

10. The overprint varnish of claim 1, wherein the varnish has a viscosity of about 5 cPs to about 16 cPs at a temperature of about 70° C. to about 100° C.

11. The overprint varnish of claim 1, wherein an oligomer is present in an amount of from about 1 percent to about 30 percent by weight of the varnish.

12. The overprint varnish of claim 9, wherein the fuser oil is amino functionalized silicone oil.

13. The overprint varnish of claim 1, wherein the phase change agent is present in an amount of from about 3 percent to about 20 percent by weight of the varnish.

14. The overprint varnish of claim 1, wherein a curable wax is present in the amount of from 1 percent by weight to about 10 percent by weight of the overprint varnish composition.

15. A method for applying an overprint varnish configured to be applied digitally, comprising:
providing a substrate;
applying an image to a substrate;
fusing the image to the substrate using a fuser oil or release fluid;
at least partially coating at least one of the image or the substrate with the overprint varnish; and
curing the overprint varnish,
wherein the overprint varnish comprises:
a varnish vehicle comprising at least one of a monomer, an oligomer, or a mixture thereof;
a siloxane-based wetting additive comprising a functional moiety that has an affinity for the varnish vehicle; and
optionally, a phase change agent.

16. The method of claim 15, wherein the overprint varnish is applied to at least one of the substrate or the image less than 5 seconds after the image is fused to the substrate.

17. The method of claim 15, wherein the overprint varnish is applied digitally to at least one of the substrate or the image.

18. The method of claim 15, wherein the overprint varnish maintains a Pa roughness of below 6 microns after coating the substrate or the image with fuser oil thereon.

19. A printing apparatus comprising:
a print engine that fuses an image to a substrate using a fuser oil or release fluid;
a coating device that digitally applies an overprint varnish to the substrate with the image thereon; and
a curing station;
wherein the overprint varnish comprises:
a varnish vehicle comprising at least one of a monomer, an oligomer, or a mixture thereof;
a siloxane-based wetting additive comprising a functional moiety that has an affinity for the varnish vehicle; and
optionally, a phase change agent.

20. The apparatus of claim 19, wherein the apparatus is configured to apply the overprint varnish to the substrate within 5 seconds after the image is fused to the substrate.
